(19) United States
(12) Patent Application Publication
(10) Pub. No.: US 2008/0166512 A1
(43) Pub. Date: Jul. 10, 2008

(54) WIDE ROLL ADHESIVE TAPE AND DISPENSING APPARATUS

(76) Inventors: THOMAS SALMON, Franklin, MA (US); Jerry Serra, Chelmsford, MA (US)

Correspondence Address: MALDJIAN & FALLON LLC, 365 BROAD ST. , 3RD FLOOR, RED BANK, NJ, 07701, US

(21) Appl. No.: 12/051,699

(22) Filed: Mar. 19, 2008

Related U.S. Application Data
(63) Continuation of application No. 11/075,996, filed on Mar. 9, 2005, now abandoned.

(51) Int. Cl. B32B 33/00; B32B 7/12; B32B 27/30

(52) U.S. Cl. 428/41.4; 428/99; 428/41.8

(57) ABSTRACT

Embodiments of the present invention generally relate to a wide tape and dispenser associated therewith. In one embodiment, a wide duct tape comprises a backing layer having a scrim disposed therein, and an adhesive layer disposed on a surface of the backing layer; wherein the wide duct tape has a width between about 8 inches and about 12 inches.

### CROSS-REFERENCES TO RELATED APPLICATIONS

This application is a continuation of U.S. application Ser. No. 11/075,996, filed Mar. 9, 2005, the entire disclosure of which is incorporated herein by reference.

### BACKGROUND OF THE INVENTION

1. Field of the Invention

This application relates to adhesive tape and more particularly to wide roll tape and associated dispensing apparatus.

2. Description of the Related Art

Embodiments of the present invention generally relate to adhesives. In particular, embodiments of the present invention relates to pre-shaped adhesives and methods.

Many industrial, commercial and residential projects require repair, sealing, joining, and/or fastening of materials that have holes, gaps or openings. Some of these areas can be geometric shapes or irregular shapes and may be relatively wide.

Currently, adhesives are sold as tape, which is available in rolls of about 2-4 inch widths with varying thread counts. If areas needing an adhesive are large or not square or rectangular in shape, currently available adhesive tapes are inefficient in repairing, sealing, joining, and/or fastening these areas. Due to existing shape and size limitations of adhesive tape, multiple pieces or applications are required to cover these large areas of various shapes and sizes. Multiple applications are undesirable because of the added weight, overlaps, etc. The tape in accordance with the present invention provides increased speed of repair, customization of required sizes and shapes for repair larger than 2″ or 3″ offered by standard width tape.

In addition, the width and thread count associated with a cloth tape, such as duct tape, determines the difficulty and sharpness of a tear. When a desired length of tape is needed, the tape is usually torn by hand. This may be difficult based on the desired length and width of tape needed, as well as the thickness or thread count.

Thus, there is a need in the art for improved adhesive tapes and associated dispensing apparatus.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawing. It is to be noted, however, the appended drawing illustrates only typical embodiments of embodiments encompassed within the scope of the present invention, and, therefore, is not to be considered limiting, for the present invention may admit to other equally effective embodiments, wherein:

FIG. 1 is a perspective view of a wide adhesive roll in accordance with an embodiment of the present invention;

FIG. 2 illustrates a sectional view of FIG. 1 cut along line a-a in accordance with an embodiment of the present invention;

FIG. 3 is a top plan view of a dispenser in accordance with an embodiment of the present invention;

FIG. 4 is a side view of cutter means in accordance with an embodiment of the present invention;

FIG. 5 is a top plan view of a dispenser in accordance with an embodiment of the present invention;

FIG. 6 is a side view of cutter means in accordance with an embodiment of the present invention; and

FIG. 7 illustrates a perspective view of roll 10 positioned in dispenser 200 in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

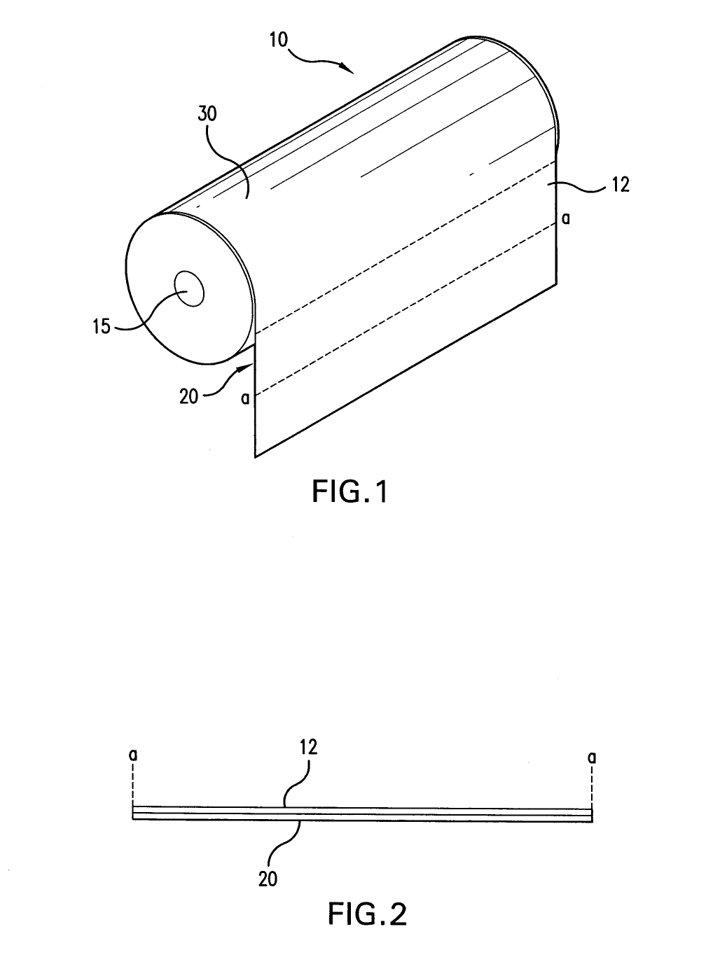

FIG. 1 illustrates a perspective view of a wide roll of tape 10 in accordance with an embodiment of the invention. Tape 10 is shown partially unwound. Adhesive tape, for example, duct tape is traditionally manufactured in rolls that are 2-4 inches in width. However, as noted above, many uses for such tape require much wider rolls, for example, 8-12 inches wide and even wider. Tape roll 10 includes tape 30 having an adhesive side 20, a non adhesive side 12 and a roll tube 15 around which, tape 30 is wound. Tube 15 may be comprised of cardboard or other material sufficiently rigid to withstand the weight of tape 30 wound around tube 15. Tube 15 may extend beyond the width of tape 30. Additionally, a release liner, not shown, may also be employed for tapes with high adhesion to prevent the tape from sticking to itself thereby compromising unrolling.

FIG. 2 depicts a sectional view of FIG. 1 cut along line a-a illustrating adhesive side 20 and corresponding non-adhesive side 12. The non-adhesive side 12 of tape 30 may be any backing used in the adhesive industry such as, but not limited to, biaxially-oriented polypropylene backing (BOPP), cloth, crepe paper, fiber filled, fiberglass cloth, flatback paper, foil, foil/tri-directional/paper, or glass fiber—BOPP, and the like. The adhesive side 20 can be any adhesive used in the industry such as, but not limited to, acrylic, rubber, polyurethane, silicone or urethane, and the like. The rubber used for adhesive can be any rubber used in the adhesives industry such as, but not limited to, butyl rubber, flame retardant rubber, hot melt rubber, natural and synthetic rubber, natural rubber, synthetic rubber, or reclaim rubber, and the like.

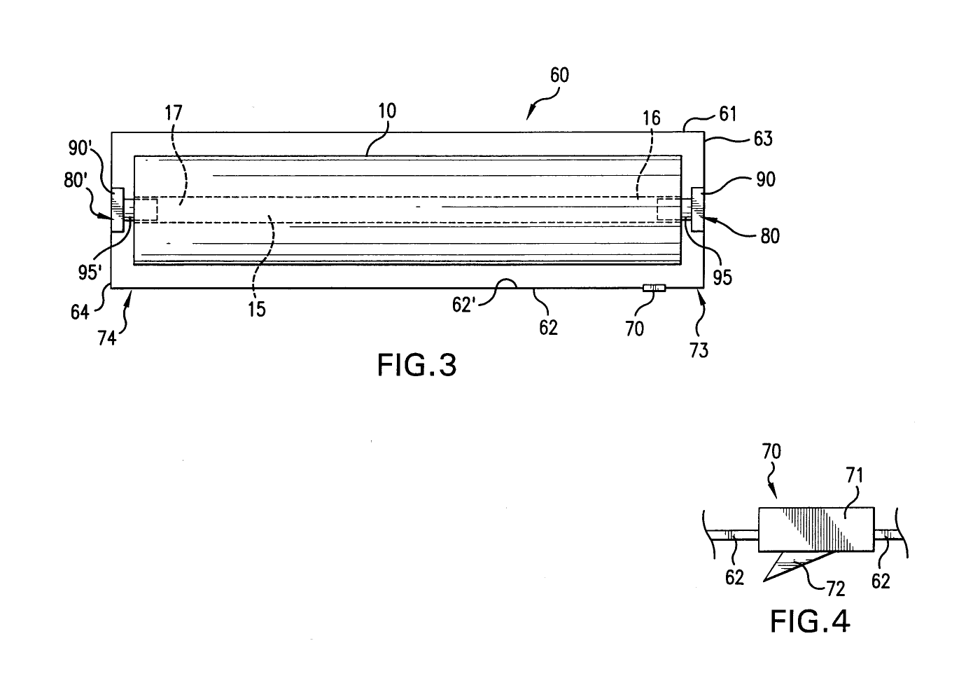

FIG. 3 illustrates a top plan view of roll 10 within dispenser 60. Dispenser 60 has a generally rectangular shape having elongated sides 61, 62 and connecting sides 63 and 64 adapted in length and width to receive roll 10. Dispenser 60 also includes a floor portion (not shown) attached to sides 61, 62, 63 and 64 to support roll 10. The interior of side 63 has disposed thereon an axis portion 80 comprising support member 90 and elongated tube insert 95. Tube insert 95 is configured to be received by tube 15 at a first end 16 and may also extend through the length of tube 15 depending on the support needed for roll 10. Similarly, interior of side 64 has disposed thereon an axis portion 80′ comprising support member 90′ and elongated tube insert 95′. Tube insert 95′ is configured to be received by tube 15 at a second end 17. Axis portions 80 and 80′ are configured to allow ease of rotation of roll 10 within dispenser 60. Again, roll 10 may be relatively heavy because of its width and length as compared to conventional tape rolls having typical widths of 2-4 inches.

Axis portions 80 and 80′ may be comprised of cardboard, disposable plastic or other material sufficiently rigid to support roll 10 within dispenser 60. Alternatively, roll 10 may be disposed within dispenser 60 without axis portions 80 and 80′. In this embodiment, roll 10 rests on the floor portion of dispenser 60 and unrolled using greater force as compared with the use of axis portions 80 and 80′.

Dispenser 60 may also include cutter means 70 positioned on or disposed in elongated side 62. FIG. 4 illustrates a side view of cutter means 70. Cutter means 70 includes holder 71 and cutter 72. Cutter 72 may be a blade made from metal, sharp plastic or other material having necessary rigidity to tear or cut tape 30 as well as a release liner if employed. Preferably, cutter 72 is disposed on the inside 62′ of dispenser wall 62 for obvious safety concerns. In practice, as a length of tape 30 is unrolled from roll 10 to a desired length, cutter means 70 traverses across tape 30 from a first end 73 of side 62 to a second end 74 of side 62 thereby engaging cutter 72 across tape 30. A user may also traverse cutter means 70 a portion of the length of wall 62 depending on the size of tape desired.

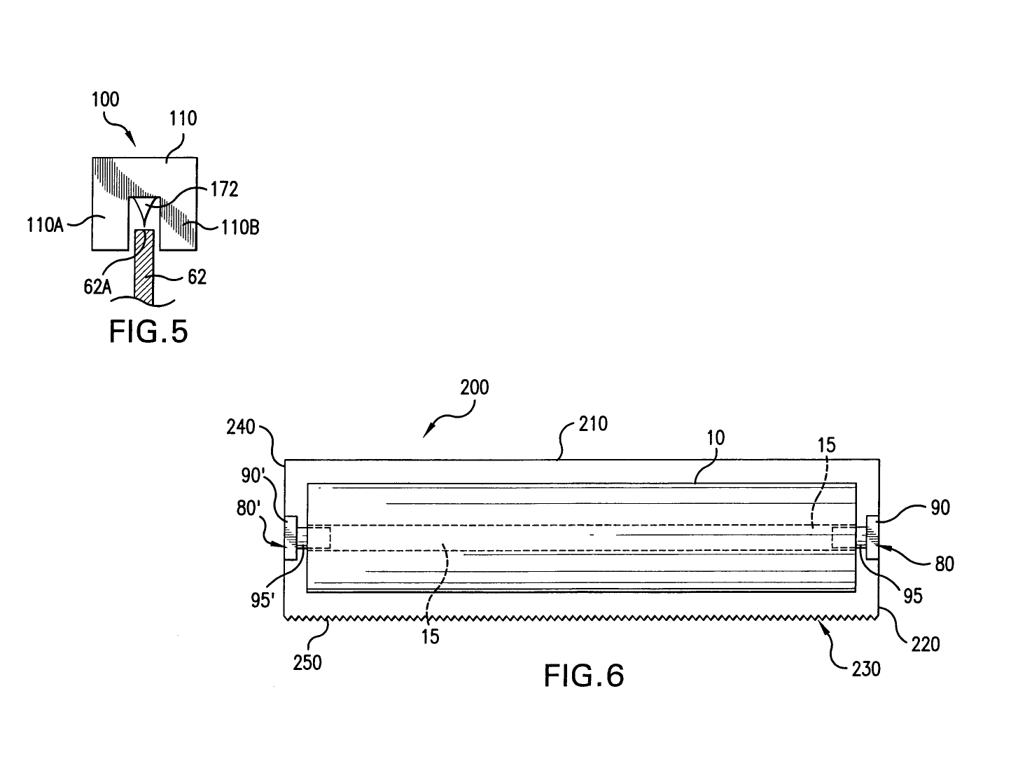

FIG. 5 illustrates a cross sectional view of cutter means 100 in accordance with an embodiment of the present invention. Cutter means 100 may include cutter holder 110 and cutter 172. Cutter holder may include extending side walls 110A and 110B between which cutter 172 is disposed. Side walls 110A and 110B slidably engage dispenser wall 62. The length of side walls 110A and 110B may be determined by the width of dispenser wall 62 and/or size of cutter 172. Cutter 172 may be a blade made from metal or sharp plastic having necessary rigidity to tear or cut tape 30. In operation, cutter means 100 is positioned at either end 73 or 74 of wall 62 sufficient to allow tape 30 to be unrolled; tape 30 is unrolled over top portion 62A of wall 62 to a desired length; and cutter means 100 traverses the length or a portion of the length of wall 62, thereby cutting tape 30. In this embodiment, the cutter element is disposed within holder 110 to provide safety. Alternatively, cutter 172 may be integrally formed with or attached to either side wall 110A and/or 110B of holder 110. Accordingly, side walls 110A and 110B may only be of sufficient length to slidably engage dispenser wall 62.

FIG. 6 illustrates a top plan view of roll 10 within dispenser 200. Dispenser 200 also has a generally rectangular shape similar to dispenser 60 with elongated sides 210, 230 and connecting sides 220 and 240 adapted in length and width to receive roll 10. Dispenser 200 also includes a floor portion (not shown) attached to sides 210, 220, 230 and 240 to support roll 10.

The interior of side 220 and interior of side 240 may have disposed thereon axis portions 80 and 80′, respectively as described above in connection with dispenser 60. Again, axis portions 80 and 80′ are configured to allow ease of rotation of roll 10 within dispenser 200. The top portion of wall 230 includes a serrated edge 250 which may be a metal or rigid plastic member attached to wall 230 having sufficient sharpness to cut tape 30 upon receipt of a downward force. In operation, tape 30 is unrolled to a desired length and a sufficient downward force is applied to engage tape 30 against serrated edge portion 250 to cut or tear tape 30.

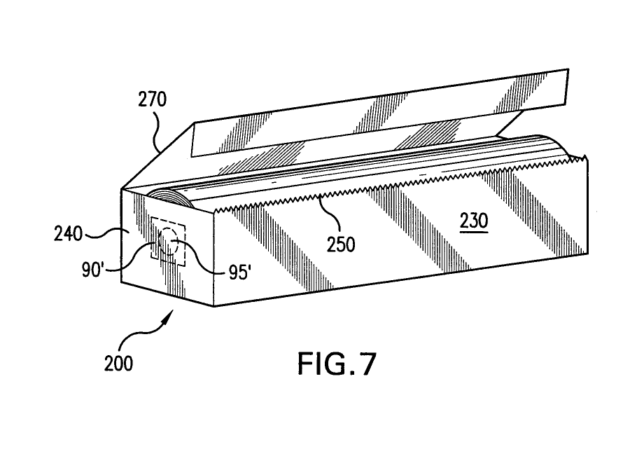

FIG. 7 illustrates a perspective view of roll 10 positioned in dispenser 200 in accordance with an embodiment. Dispenser 200 include cover 270 configured to cover roll 10 within dispenser 200. Cover 270 provides protection for tape rolls 10 as well as added packaging configurations.

While the foregoing is directed to embodiments of the present invention, other and further embodiments of the invention may be devised without departing from the basic scope thereof.

What is claimed is:

1. A wide adhesive tape comprising:
a backing layer; and
an adhesive layer disposed on a surface of the backing layer;
wherein the wide adhesive tape has a width between about 8 inches and about 12 inches.

2. The wide adhesive tape of claim 1, wherein the wide roll adhesive tape has a width of about 12 inches.

3. The wide adhesive tape of claim 1, further comprising a release liner disposed on the adhesive layer.

4. The wide adhesive tape of claim 1, further comprising a scrim material disposed within the backing.

5. The adhesive tape of claim 4, wherein the scrim material comprises a woven cloth.

6. The adhesive tape of claim 4, wherein the wide adhesive tape is a duct tape.

7. The wide adhesive tape of claim 1, wherein the adhesive layer comprises at least one of acrylic, polyurethane, silicone, or rubber.

8. The wide adhesive tape of claim 7, wherein the rubber comprises at least one of butyl rubber, flame-retardant rubber, hot melt rubber, natural rubber, synthetic rubber, and reclaim rubber.

9. A wide duct tape comprising:
a backing layer having a scrim disposed therein; and
an adhesive layer disposed on a surface of the backing layer;
wherein the wide duct tape has a width between about 8 inches and about 12 inches.

10. The wide duct tape of claim 9, wherein the wide roll adhesive tape has a width of about 12 inches.

11. The wide duct tape of claim 9, wherein the adhesive layer comprises at least one of acrylic, polyurethane, silicone, or rubber.

12. The wide duct tape of claim 12, wherein the rubber comprises at least one of butyl rubber, flame-retardant rubber, hot melt rubber, natural rubber, synthetic rubber, and reclaim rubber.

13. The wide duct tape of claim 9, further comprising a release liner disposed on the adhesive layer.

14. A wide duct tape comprising:
a backing layer having a woven cloth scrim disposed therein;
an adhesive layer disposed on a surface of the backing layer; and
a release liner disposed on the adhesive layer;
wherein the wide duct tape has a width between about 8 inches and about 12 inches.

15. The wide duct tape of claim 14, wherein the wide roll adhesive tape has a width of about 12 inches.

16. The wide duct tape of claim 14, wherein the adhesive layer comprises at least one of acrylic, polyurethane, silicone, or rubber.

17. The wide duct tape of claim 16, wherein the rubber comprises at least one of butyl rubber, flame-retardant rubber, hot melt rubber, natural rubber, synthetic rubber, and reclaim rubber.
